(19) United States
(12) Patent Application Publication
(10) Pub. No.: US 2023/0186370 A1
(43) Pub. Date: Jun. 15, 2023

(54) APPLYING SPECIFIC CHARACTERISTICS TO INDIVIDUALS OF THE SAME PRODUCT

(71) Applicant: The Pokémon Company, Tokyo (JP)

(72) Inventors: Yusuke MIZUGUCHI, Tokyo (JP); Shinya SATO, Tokyo (JP); Mari TOMIOKA, Tokyo (JP)

(73) Assignee: The Pokémon Company, Tokyo (JP)

(21) Appl. No.: 18/104,308

(22) Filed: Feb. 1, 2023

Related U.S. Application Data
(63) Continuation of application No. PCT/JP2021/028580, filed on Aug. 2, 2021.

(30) Foreign Application Priority Data
Aug. 5, 2020 (JP) 2020-132745

(51) Int. Cl. G06Q 30/0601

(52) U.S. Cl. CPC G06Q 30/0631; G06Q 30/0629

(57) ABSTRACT

An information provision device includes processing circuitry for acquiring information relating to a customer, and for referring to at least the information relating to the customer in order to present the customer with information relating to characteristics given to a subject individual, which is one individual of a subject product to which characteristics are individually given so that individual differences exist between individuals of the same item.

### CROSS-REFERENCE TO RELATED APPLICATIONS

This application is a bypass continuation of PCT/JP2021/028580, filed on Aug. 2, 2021, which claims priority to JP 2020-132745, filed on Aug. 5, 2020, the entire contents of each are incorporated herein by reference.

### BACKGROUND

### Field

The present disclosure relates to an information provision device, an information provision method, an information provision program, and an information provision system.

### Description of the Related Art

Presenting information that is suitable for individual customers can bring benefits to the customers.

In a known system disclosed in PTL 1, a purchase history is managed for each customer, and when a customer pays for a purchased product and the purchased product is in the purchase history of the customer, or when there is a product that the customer has forgotten to buy, a warning is issued or a new product matching the preferences of the customer is suggested.

### CITATION LIST

### Patent Literature

[PTL 1] Japanese Patent Application Publication No. 2005-228179

### SUMMARY

### Technical Problems

The system described in PTL 1 provides each customer with information corresponding to the purchase history thereof. However, the system is premised on the handling of products that cannot be used permanently (in other words, products that must be replaced) such as consumables (seasonings, for example), or products that are typically unlikely to be purchased in duplicate, such as books. Character goods such as soft toys, for example, are products that some customers may wish to purchase in duplicate, but when this system is applied as is to such products, it may not always be possible to present information that is suitable for the customer.

An object of the present disclosure is to provide a novel customer experience related to the purchase of a product.

### Solutions to Problems

An information provision device according to an aspect of the present disclosure includes means for acquiring information relating to a customer, and means for referring to at least the information relating to the customer in order to present the customer with information relating to characteristics given to a subject individual, which is one individual of a subject product to which characteristics are individually given so that individual differences exist between individuals of the same item.

### Advantages

According to the present disclosure, it is possible to provide a novel customer experience related to the purchase of a product.

### BRIEF DESCRIPTION OF DRAWINGS

FIG. 1 is a block diagram showing a configuration of an information provision system according to an embodiment.

FIG. 2 is a block diagram showing a configuration of a user terminal according to this embodiment.

FIG. 3 is a view showing an example of a product display.

FIG. 4 is a view showing an example of a screen presented to a customer when a certain individual product among the products shown in FIG. 3 is specified.

FIG. 5 is a view showing an example of a screen presented to a customer when a different individual product among the products shown in FIG. 3 is specified.

FIG. 6 is a view showing a data structure of a customer database according to this embodiment.

FIG. 7 is a view showing a data structure of a purchase history database according to this embodiment.

FIG. 8 is a view showing a flow of information provision processing according to this embodiment.

FIG. 9 is a view showing a data structure of a game play history database according to modification example 1.

FIG. 10 is a view showing a data structure of an inventory database according to modification example 1.

FIG. 11 is a view showing a flow of information provision processing according to modification example 2.

FIG. 12 is a view showing a flow of information provision processing according to modification example 3.

### DETAILED DESCRIPTION

An embodiment of the present disclosure will be described in detail below on the basis of the drawings. Note that in the diagrams used to illustrate the embodiment, identical constituent elements will in principle be allocated identical reference symbols, and repetitive description thereof will be omitted.

### (1) Configuration of Information Provision System

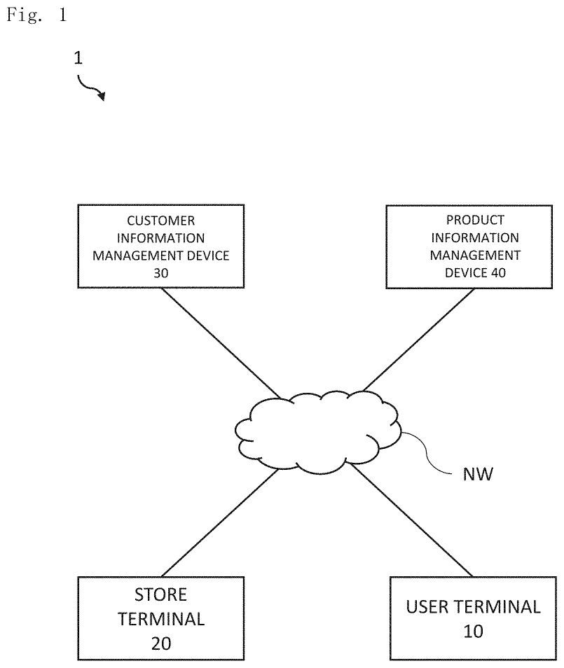

A configuration of an information provision system will now be described. FIG. 1 is a block diagram showing a configuration of the information provision system according to this embodiment.

As shown in FIG. 1, an information provision system 1 includes a user terminal 10 (an example of the “information provision device”), a store terminal 20, a customer information management device 30, and a product information management device 40.

The user terminal 10, the store terminal 20, the customer information management device 3, and the product information management device 40 are connected by a network (the Internet or an intranet, for example) NW.

The user terminal 10 is an information processing device (i.e., a computer) possessed by a customer. The user terminal 10 is a smartphone, a tablet terminal, a personal computer, or a wearable device, for example. The user terminal 10 provides information that is suitable for the customer in response to an operation performed by the customer.

The store terminal 20 is an information processing device disposed in a store. For example, the store terminal 20 is a payment terminal, a customer service robot, a product search terminal, a check-in terminal, or a combination thereof. The store terminal 20 supports a purchasing action performed by the customer in response to an operation performed by the customer or a salesperson.

The customer information management device 30 is an information processing device for managing information relating to customers. For example, the customer information management device 30 is a web server, a database server, or a combination thereof.

The product information management device 40 is an information processing device for managing information relating to products. For example, the product information management device 40 is a web server, a database server, or a combination thereof.

### (1-1) Configuration of User Terminal

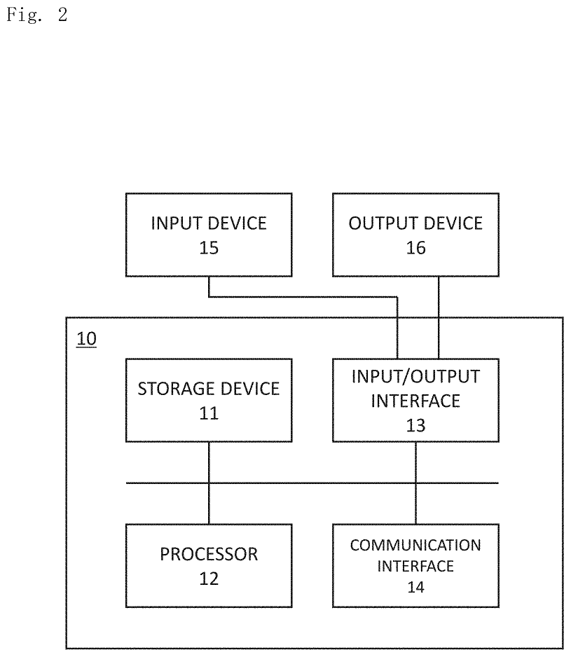

The configuration of the user terminal 10 will now be described. FIG. 2 is a block diagram showing the configuration of the user terminal according to this embodiment.

As shown in FIG. 2, the user terminal 10 includes a storage device 11, a processor 12, an input/output interface 13, and a communication interface 14. The user terminal 10 can be connected to at least one of an input device 15 and an output device 16.

The storage device 11 is configured to store programs and data. For example, the storage device 11 is a combination of a ROM (Read Only Memory), a RAM (Random Access Memory), and storage (a flash memory or a hard disk, for example).

The programs include the following programs, for example.

An OS (Operating System) program
A program for an application (a web browser, for example) that executes information processing

The data include the following data, for example.

A database that is referred to during information processing
Data acquired by executing the information processing (in other words, execution results of the information processing)

The processor 12 is configured to realize the functions of the user terminal 10 by activating the programs stored in the storage device 11. The processor 12 is an example of a computer.

The input/output interface 13 is configured to acquire signals (for example, user instructions, sensing signals, or combinations thereof) from the input device 15 and output signals (for example, image signals, voice signals, or combinations thereof) to the output device 16.

The input device 15 is a keyboard, a pointing device, a touch panel, a sensor, or a combination thereof, for example.

The output device 16 is a display, a speaker, or a combination thereof, for example.

The communication interface 14 is configured to control communication between the user terminal 10 and an external device (for example, at least one of the store terminal 20, the customer information management device 30, and the product information management device 40).

### (1-2) Configurations of Store Terminal, Customer Information Management Device, and Product Information Management Device

The store terminal 20, the customer information management device 30, and the product information management device 40 are all information processing devices and may include the same types of hardware as the user terminal 10.

### (2) Outline of Embodiment

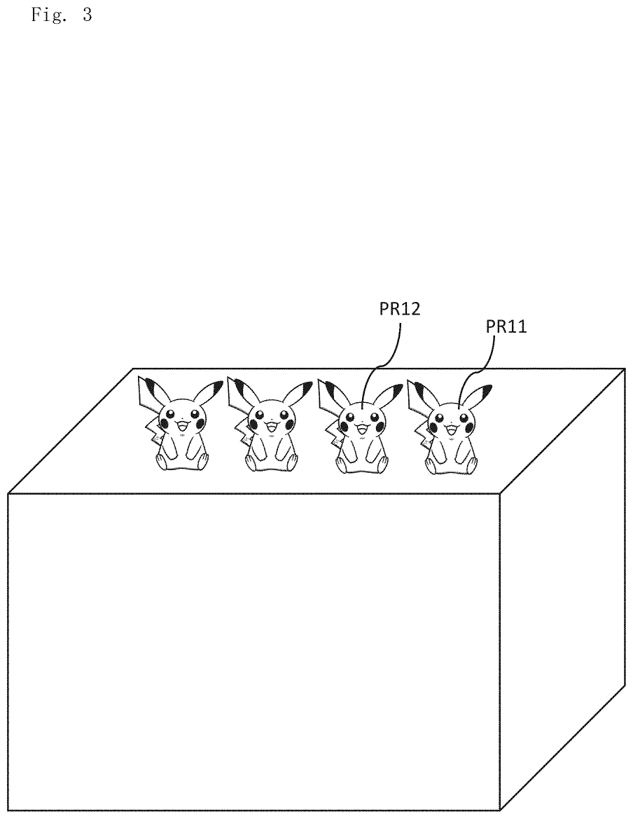

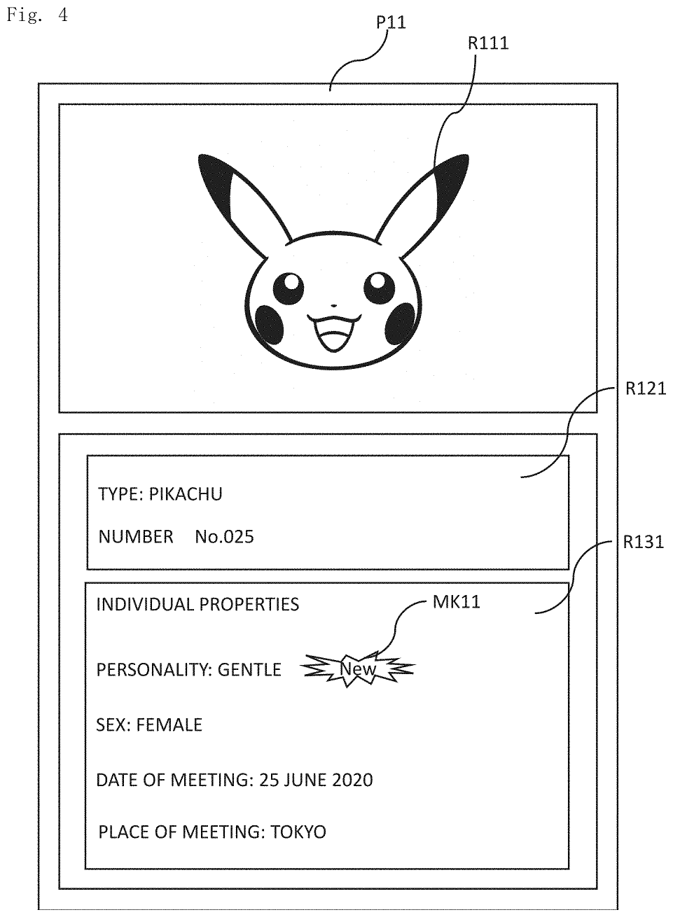

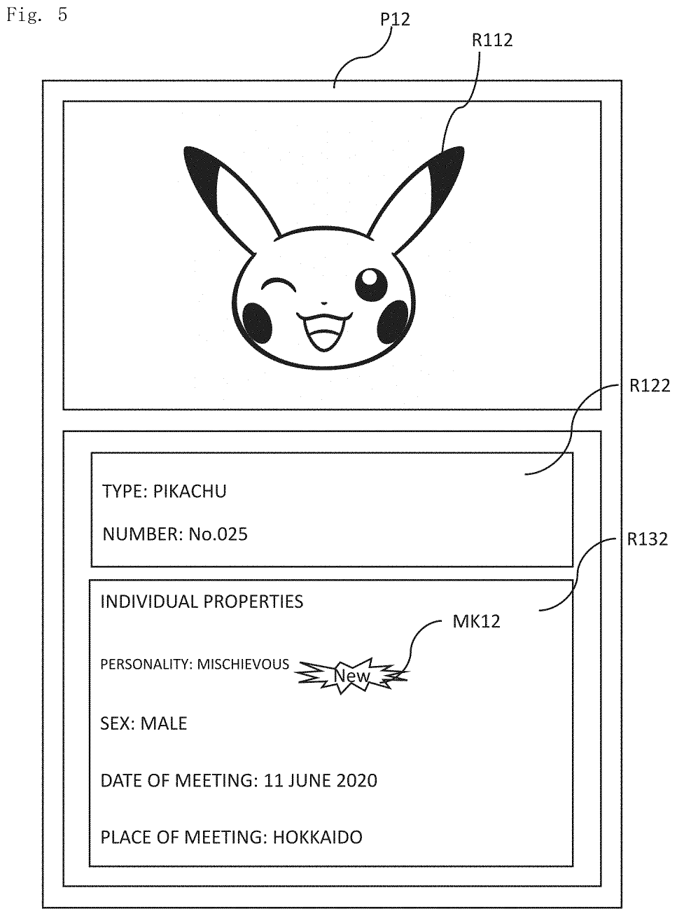

An outline of this embodiment will now be described. FIG. 3 is a view showing an example of a product display. FIG. 4 is a view showing an example of a screen presented to a customer when a certain individual product among the products shown in FIG. 3 is specified. FIG. 5 is a view showing an example of a screen presented to a customer when a different individual product among the products shown in FIG. 3 is specified.

The user terminal 10 of this embodiment provides information that contributes to a purchasing action performed by a customer in a store. As shown in FIG. 3, one or more individual products (referred to hereafter as “individuals”) PR11, PR12, . . . of each of one or more products are displayed in the store.

For example, the product (referred to hereafter as the “subject product”) for which information is to be provided is a type of character goods, fan goods, or other content-related goods, and is an industrial product designed to have a uniform quality. However, the subject product is not limited thereto. Each individual of the subject product is individually given characteristics so that individual differences exist between the individual and other individuals of the same item.

The characteristics may be external characteristics (in other words, characteristics that are distinguishable to the naked eye of the customer), non-external characteristics, or a combination thereof. The non-external characteristics may be stored as information on an information carrier (for example, a wireless tag, a one-dimensional code, or a two-dimensional code) attached to the individual, for example. The characteristics may also be characteristics belonging to a real or imaginary entity (a game character, for example) on which the product is based, for example. By intentionally giving individual differences to the product in this manner, customers are more likely to feel attracted to individuals they have purchased or an individual they are about to purchase.

The user terminal 10 presents the customer with information relating to the characteristics given to one of the individuals (referred to hereafter as the “subject individual”) of the subject product. Thus, the customer can more easily decide which individual to purchase from a product having individual differences. The subject individual is identified in response to specification thereof by the customer, for example.

When the customer specifies the individual PR11 in FIG. 3, the user terminal 10 presents information to the customer by displaying a screen P11 shown in FIG. 4, for example, on the display. The screen P11 includes a display region R111, a display region R121, and a display region R131.

An icon of the subject individual (the individual PR11) is displayed in the display region R111.

The icon of the subject individual may be shared by individuals of the same item or determined in accordance with the characteristics (for example, age, sex, or a combination thereof) of the individual. Alternatively, the icon may itself be one element of the characteristics of the individual.

General information (i.e., information that is shared between individuals) about the subject product is displayed in the display region R121. The general information about the subject product indicates, for example, the type of entity on which the subject product is based, a product number, or a combination thereof.

Information (referred to hereafter as “individual property information”) relating to the characteristics given to the subject individual is displayed in the display region R131.

The individual property information indicates, for example, personality, special skills, hobbies, preferences, sex, date of meeting, birthday, place of meeting, birthplace, age, other parameters, or a combination thereof.

Further, a “New” mark MK11, for example, is added to and displayed in the section “personality: gentle” among the individual property information items displayed in the display region R131. The “New” mark MK11 means that none of the individuals of the subject product previously purchased by the customer have the characteristic “personality: gentle”.

When the customer specifies a different individual PR12 to the individual PR11, the user terminal 10 presents information to the customer by displaying a screen shown in FIG. 5, for example, on the display. The screen P12 includes a display region R112, a display region R122, and a display region R132.

The icon of the subject individual (the individual PR12) is displayed in the display region R112.

The general information about the subject product is displayed in the display region R122. The individual PR12 is the same as the individual PR11, and therefore the same information as that displayed in the display region R121 is displayed in the display region R122.

The individual property information about the subject individual is displayed in the display region R132.

Further, a “New” mark MK12, for example, is added to and displayed in the section “personality: mischievous” among the individual property information items displayed in the display region R132. The “New” mark MK12 means that none of the individuals of the subject product previously purchased by the customer have the characteristic “personality: mischievous”.

Thus, in response to identification of the subject individual, the user terminal 10 presents not only information relating to the subject product but also information (for example, the information displayed in the display regions R131 and R132) relating to the subject individual. As a result, the customer can decide whether or not to purchase while keeping in mind the individual differences in the subject product.

Moreover, by referring to information relating to the customer, the user terminal 10 adds and displays the “New” mark (for example, the “New” marks MK11 and MK12) to an item, among the individual properties of the subject individual, that none of the individuals previously purchased by the customer have. As a result, the customer can use the presence or absence of the “New” mark as a cue for deciding whether or not to purchase the subject individual. For example, using the number of “New” marks as a cue, the customer can forgo the purchase of a subject individual having similar individual properties to a purchased individual or decide to purchase a subject individual having different individual properties to a purchased individual.

### (3) Databases

Databases of this embodiment will now be described. The following databases are stored in a storage device in the interior of the customer information management device 30 or a storage device connected to the customer information management device 30 by a network.

### (3-1) Customer Database

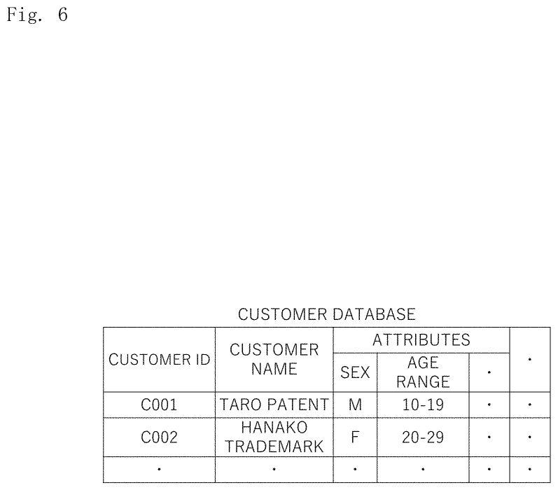

A customer database of this embodiment will now be described. FIG. 6 is a view showing a data structure of the customer database according to this embodiment.

As shown in FIG. 6, the customer database includes a “customer ID” field, a “customer name” field, and an “attributes” field. The respective fields are associated with each other.

The customer database stores customer information. The customer information is basic information about customers.

The customer database corresponds to a member database of a store or a store group, for example, but is not limited thereto. The customer database may correspond to a user database of a game, an application, a service, or a platform related to the product.

Customer IDs are stored in the “customer ID” field. The customer ID is information for identifying a customer.

Customer name information is stored in the “customer name” field. The customer name information is information related to the name (for example, the real name or a nickname) of the customer.

Attribute information is stored in the “attributes” field. The attribute information is information relating to attributes of the customer. In the example of FIG. 6, sex and age range are illustrated as the attributes of the customer, but the attributes are not limited to these examples.

### (3-2) Purchase History Database

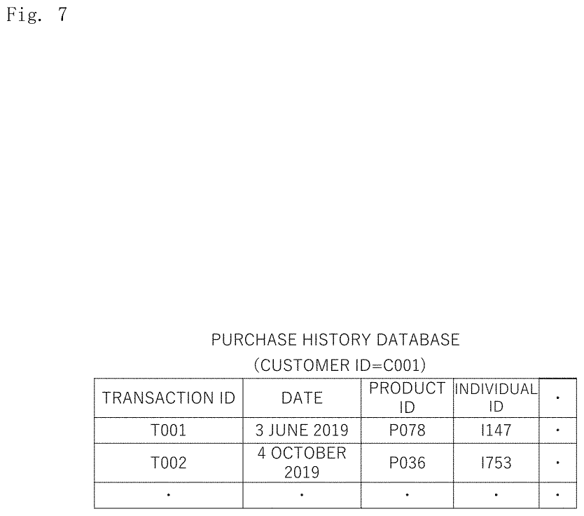

A purchase history database of this embodiment will now be described. FIG. 7 is a view showing a data structure of the purchase history database according to this embodiment.

As shown in FIG. 7, the purchase history database includes a “transaction ID” field, a “date” field, a “product ID” field, and an “individual ID” field. The respective fields are associated with each other.

The purchase history database stores purchase history information. The purchase history information is information relating to the products and individuals thereof purchased by the customer and the times of the purchases.

The purchase history database is associated with the customer database (FIG. 6).

As shown in FIG. 7, a table storing purchase history information corresponding to each customer ID can be extracted from the purchase history database.

Transaction IDs are stored in the “transaction ID” field. The transaction ID is information for identifying a transaction forming the purchase history.

Purchase date information is stored in the “date” field. The purchase date information is information relating to the date of the transaction identified by the transaction ID.

Purchased product IDs are stored in the “product ID” field. The purchased product ID is information for identifying the product purchased in the transaction identified by the transaction ID.

Purchased individual IDs are stored in the “individual ID” field. The purchased individual ID is information for identifying the individual purchased in the transaction identified by the transaction ID.

### (4) Information Provision Processing

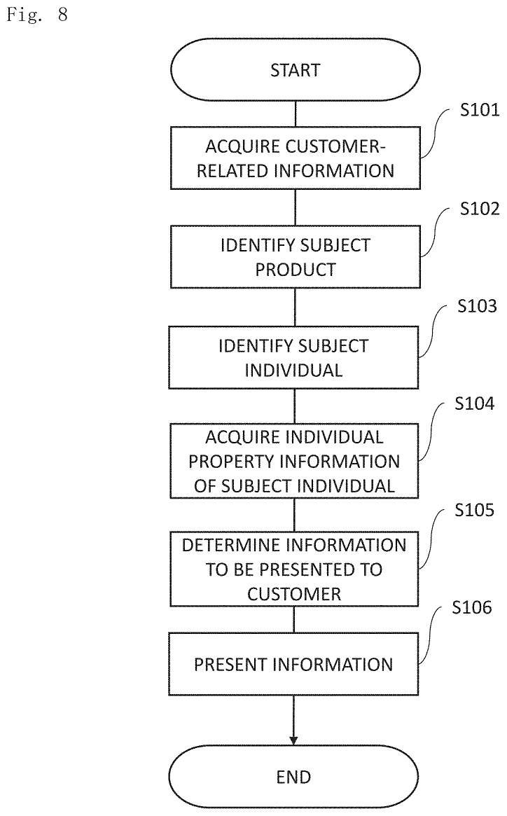

Information provision processing according to this embodiment will now be described. FIG. 8 is a view showing a flow of the information provision processing of this embodiment.

As shown in FIG. 8, the user terminal 10 executes acquisition of information relating to the customer (S101).

In this embodiment, the processor 12 acquires the purchase history information of the customer.

More specifically, the processor 12 transmits the customer ID to the customer information management device 30. The customer information management device 30 extracts the purchase history information associated with the received customer ID from the purchase history database and transmits the extracted information to the user terminal 10. The processor 12 acquires the purchase history information received by the communication interface 14.

The processor 12 can execute step 5101 at one or more of the following timings, for example.

When the customer visits the store
When the user terminal 10 reads the information carrier attached to the subject product (or one of the individuals thereof).
When the customer performs a predetermined operation on a predetermined application executed by the user terminal 10 (for example, selects a product on the application).
When the customer performs a predetermined operation on the store terminal 20 (for example, holds the user terminal 10 up to the store terminal 20).

Further, as shown in FIG. 8, the user terminal 10 executes identification of the subject product (S102).

In this embodiment, the processor 12 identifies one of the products in the store as the subject product in response to specification thereof by the customer. The customer can specify the subject product by at least one of the following means, for example. Reading the information carrier attached to the subject product (or one of the individuals thereof).

Performing a predetermined operation on a predetermined application executed by the user terminal 10 (for example, selecting the subject product on the application).
Photographing the subject product (or one of the individuals thereof).
Inputting the product name or product ID of the subject product by text, voice, or selection.
Performing a predetermined operation on the store terminal 20 (for example, holding one of the individuals of the subject product up to the store terminal 20).

The processor 12 may perform step S102 either before step S101, after step S101, or simultaneously with step S101.

Furthermore, as shown in FIG. 8, the user terminal 10 executes identification of the subject individual (S103).

More specifically, the processor 12 identifies one of the individuals of the subject product identified in step 5102 as the subject individual in response to specification thereof by the customer. The customer can specify the subject individual by at least one of the following means, for example.

Reading the information carrier attached to the subject individual
Performing a predetermined operation on a predetermined application executed by the user terminal 10 (for example, selecting the subject individual on the application).
Photographing the subject individual.
Inputting the individual name or individual ID of the subject individual by text, voice, or selection.
Performing a predetermined operation on the store terminal 20 (for example, holding the subject individual up to the store terminal 20).

The processor 12 may perform step S103 either after step S102 or simultaneously with step S102.

After step S103, the user terminal 10 executes acquisition of the individual property information of the subject individual (S104).

More specifically, the processor 12 acquires the individual property information of the subject individual identified in step S103. The processor 12 can acquire the individual property information of the subject individual by at least one of the following means, for example.

Extracting the individual property information of the subject individual from the information stored on the information carrier attached to the subject individual.
Acquiring the individual property information associated with the individual ID of the subject individual from the store terminal 20 or the product information management device 40.

After step S101 and step S104, the user terminal 10 executes determination of the information to be presented to the customer (S105).

More specifically, the processor 12 determines the information to be presented to the customer by referring to the information relating to the customer, acquired in step S101, and the individual property information of the subject individual, acquired in step S104. The processor 12 determines at least one of the following types of information, for example, as the information to be presented to the customer.

Information relating to the characteristics given to the subject individual (in other words, the information acquired in step S104)
Information indicating whether or not the customer has previously purchased one of the individuals of the subject product
When the customer has previously purchased one of the individuals of the subject product, information relating to the characteristics given to that individual (to be referred to hereafter as the “purchased individual”)
When the customer has previously purchased one of the individuals of the subject product, information indicating at least some of the characteristics given to the purchased individual
When the customer has previously purchased one of the individuals of the subject product, information relating to comparison results (matches/mismatches) between the characteristics given to the subject individual and the characteristics given to the purchased individual
When the customer has not previously purchased one of the individuals of the subject product, information indicating that the product is being purchased for the first time

After step S105, the user terminal 10 executes presentation of the information (S106).

More specifically, the processor 12 presents the information determined in step S105 to the customer by outputting the information to the output device 16. As a result, the customer can obtain material for deciding whether or not the purchase the subject individual before purchasing the subject individual. The processor 12 presents the information to the customer by at least one of the following means, for example.

Displaying an image on the display
Outputting a voice through the speaker

As described above, the user terminal according to this embodiment refers to information relating to the customer (specifically, the purchase history information) in order to present the customer with information relating to the characteristics given to the subject individual. According to this user terminal, therefore, when the customer purchases a specific individual from a product intentionally given individual differences, the purchase history of the customer can be taken into account so that appropriate information is provided. In other words, a novel customer experience can be provided. For example, the customer can be provided with the pleasure of searching for an individual having individual properties that previously purchased individuals do not have. Furthermore, when the customer wishes to purchase individuals of the same product repeatedly, the individual differences between the purchased individuals and the subject individual can be grasped easily and used in the purchasing decision.

### (5) Modification Examples

Modification examples of this embodiment will now be described.

### (5-1) Modification Example 1

Modification example 1 will now be described. Modification example 1 is an example in which a subject product or a subject individual is recommended to the customer.

In modification example 1, at least one of the following types of information can be used as the customer-related information.

The purchase history information
Information relating to a use history of the customer with respect to a game, an application, a service, or a platform related to the product (referred to hereafter as “use history information”).
Information relating to the preferences or the personality of the customer.

### (5-1-1) Databases

The databases of modification example 1 will now be described.

### (5-1-1-1) Game play history database

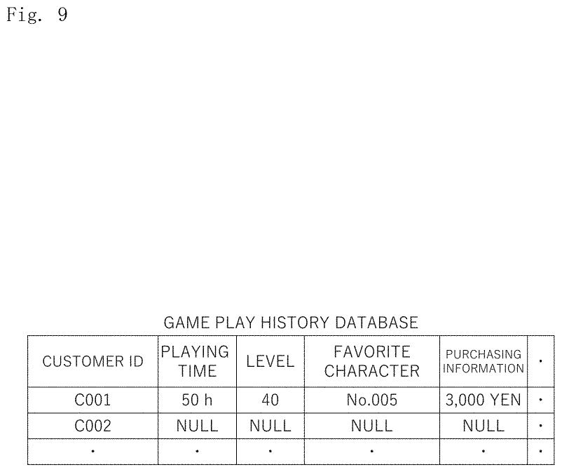

A game play history database of modification example 1 will now be described. FIG. 9 is a view showing a data structure of the game play history database of modification example 1.

The game play history database is stored in a storage device in the interior of the customer information management device 30 or a storage device connected to the customer information management device 30 by a network.

Game play history information (an example of the “use history information”) is stored in the game play history database. The game play history information is information relating to a game playing history of each customer.

As shown in FIG. 9, the game play history database includes a “customer ID” field, a “playing time” field, a “level” field, a “favorite character” field, and a “purchase information” field. The respective fields are associated with each other.

The game play history database is associated with the customer database (FIG. 6).

Customer IDs are stored in the “customer ID” field. The customer IDs may be identical to the customer IDs in the customer database (FIG. 6).

Playing time information is stored in the “playing time” field. The playing time information is information relating to the time spent by the customer playing the game.

Level information is stored in the “level” field. The level information is information relating to the level of the customer in the game.

Favorite character information is stored in the “favorite character” field. The favorite character information is information relating to a favorite character of the customer in the game.

Purchase information is stored in the “purchase information” field. The purchase information is information relating to the purchase of in-game items by the customer in the game.

### (5-1-1-2) Inventory Database

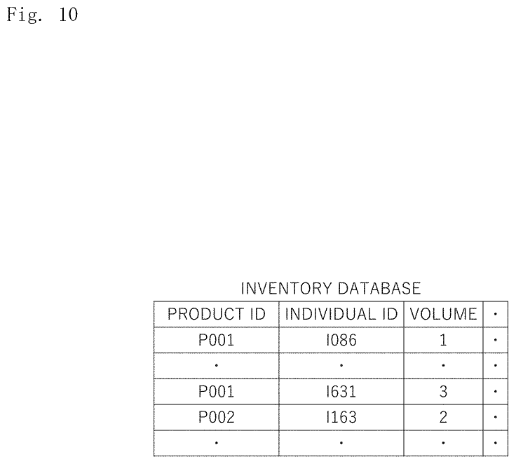

An inventory database of modification example 1 will now be described. FIG. 10 is a view showing a data structure of the inventory database according to modification example 1.

The inventory database is stored in a storage device in the interior of the product information management device 40 or a storage device connected to the product information management device 40 by a network.

The inventory database stores inventory information. The inventory information is information relating to the inventory of the individuals of each product in a store or a store group.

As shown in FIG. 10, the inventory database includes a “product ID” field, an “individual ID” field, and a “quantity” field. The respective fields are associated with each other.

Product IDs are stored in the “product ID” field. The product ID is information for identifying a product.

Individual IDs are stored in the “individual ID” field. The individual ID is information for identifying an individual of the product identified by the corresponding product ID.

Quantity information is stored in the “quantity” field. The quantity information is information relating to the inventory quantity of the individual identified by the corresponding individual ID.

### (5-1-2) Information Provision Processing

Information provision processing according to modification example 1 will now be described.

As shown in FIG. 8, the user terminal 10 executes acquisition of information relating to the customer (S101).

In modification example 1, the processor 12 acquires at least one of the following types of information as the customer-related information.

The purchase history information
The use history information
The information relating to the preferences or the personality of the customer

In a first example of acquisition of the customer-related information (S101), the processor 12 transmits the customer ID to the customer information management device 30. The customer information management device 30 extracts the purchase history information associated with the received customer ID from the purchase history database and transmits the extracted information to the user terminal 10. The processor 12 acquires the purchase history information received by the communication interface 14.

In a second example of acquisition of the customer-related information (S101), the processor 12 transmits the customer ID to the customer information management device 30. The customer information management device 30 extracts the use history information associated with the received customer ID from the use history database and transmits the extracted information to the user terminal 10. The processor 12 acquires the use history information received by the communication interface 14.

In a third example of acquisition of the customer-related information (S101), the processor 12 transmits the customer ID to the customer information management device 30. The customer information management device 30 extracts information relating to the preferences or personality of the customer, the information being associated with the received customer ID, from the customer database and transmits the extracted information to the user terminal 10. The processor 12 acquires the information relating to the preferences or personality of the customer, received by the communication interface 14.

In a fourth example of acquisition of the customer-related information (S101), the processor 12 executes a preference-related questionnaire or a personality test on the customer. The processor 12 acquires information relating to the preferences or personality of the customer by referring to response results acquired from the customer. The preference-related questionnaire or the personality test may be performed by the store terminal 20. The preference-related questionnaire may include a question asking the customer to select a preferred character from among a plurality of characters related to the product, for example.

After step S101, the user terminal 10 executes identification of the subject product (S102).

More specifically, the processor 12 requests the inventory information from the product information management device 40 and acquires the inventory information from the product information management device 40 in response. The processor 12 refers to the inventory information and the customer-related information acquired in step S101 in order to identify one of the products for which there is inventory as the subject product. The processor 12 can identify at least one of the following products, for example, as the subject product.

A product that the customer has not previously purchased
A product related to a product that the customer has previously purchased
A product having a high purchase rate among other customers having a similar purchase history or use history, similar preferences, or a similar personality to the customer
A product relating to the number of times the customer has purchased, possessed, or consumed a type of character or item in the game related to the product
A product that aligns with the preferences or personality of the customer
A product determined by lottery

After step S102, the user terminal 10 executes identification of the subject individual (S103).

More specifically, the processor 12 refers to the inventory information and the customer-related information acquired in step S101 in order to identify one of the individuals of the subject product identified in step S102 as the subject individual. The processor 12 can identify at least one of the following products, for example, as the subject individual.

An individual having a characteristic that none of the previously purchased individuals of the subject product have
An individual having a characteristic with a high purchase rate among other customers with a similar purchase history or use history, similar preferences, or a similar personality to the customer
An individual having characteristics (for example, identical or similar individual properties) that correspond to a character used by the customer in the game related to the subject product
An individual having a characteristic that is given only when the customer is determined to satisfy a predetermined condition in the game related to the subject product (for example, owning a predetermined character, having previously purchased a predetermined game item, having purchased a predetermined game item a predetermined number of times, and so on)
An individual having characteristics that align with the preferences or personality of the customer
An individual determined by lottery

After step S103, the user terminal 10 executes acquisition of the individual property information of the subject individual (S104), determination of the information to be presented to the customer (S105), and presentation of the information (S106) in a similar manner to FIG. 8.

As described above, the user terminal according to this embodiment refers to information relating to the customer in order to identify the subject product and the subject individual. According to this user terminal, therefore, a product serving as a purchase candidate and a specific individual thereof can be selected without being specified by the customer, whereupon the customer can be provided with information. In other words, a novel customer experience can be provided. For example, a subject individual possibly having characteristics that meet the potential requirements of the customer can be recommended without the customer having to search through the store or check the individual properties of the displayed individuals of the product one by one.

### (5-2) Modification Example 2

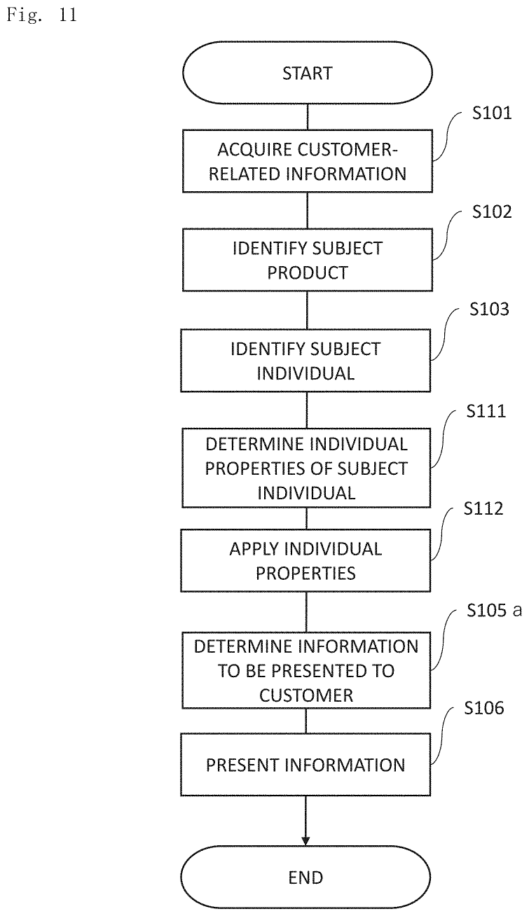

Modification example 2 will now be described. Modification example 2 is an example in which the individual properties of the subject individual are determined after the subject individual is identified. FIG. 11 is a view showing a flow of information provision processing according to modification example 2.

As shown in FIG. 11, the user terminal 10 executes acquisition of the customer-related information (S101), identification of the subject product (S102), and identification of the subject individual (S103) in a similar manner to FIG. 8.

After step S103, the user terminal 10 executes determination of the individual properties of the subject individual (S111).

More specifically, the processor 12 determines the characteristics to be given to the subject individual. In step S111, the processor 12 may, but does not have to, refer to the customer-related information acquired in step S101. The processor 12 determines the individual properties of the subject individual by at least one of the following means, for example.

Selecting characteristics that differ at least partially from those of the individuals previously purchased by the customer
Selecting characteristics corresponding to those of a character used by the customer in the game related to the subject product (for example, identical individual properties to the character)
Selecting characteristics that align with the preferences or personality of the customer
Determining the individual properties by lottery

After step S111, the user terminal 10 executes application of the individual properties (S112).

More specifically, the processor 12 applies the individual properties determined in step S111 to the subject individual. The processor 12 applies the individual properties to the subject individual by at least one of the following means, for example.

Requesting the product information management device 40 to rewrite the individual property information of the subject individual (for example, the individual property information associated with the individual ID of the subject individual in the database)

Rewriting the information stored on the information carrier (a wireless tag, for example) attached to the subject individual

Note that a reader/writer (an RFID reader/writer, for example) can be used to rewrite the information stored on the information carrier. The reader/writer can be connected to the user terminal 10 or the store terminal 20 as an input/output device.

After step S112, the user terminal 10 executes determination of the information to be presented to the customer (S105a).

More specifically, the processor 12 determines the information to be presented to the customer by referring to the customer-related information acquired in step S101 and the individual properties of the subject individual, determined in step S111. The processor 12 determines at least one of the following types of information, for example, as the information to be presented to the customer.

Information relating to the characteristics given to the subject individual (in other words, information relating to the individual properties determined in step S111)
Information indicating whether or not the customer has previously purchased one of the individuals of the subject product
When the customer has previously purchased one of the individuals of the subject product, information relating to the characteristics given to the purchased individual
When the customer has previously purchased one of the individuals of the subject product, information indicating at least some of the characteristics given to the purchased individual
When the customer has previously purchased one of the individuals of the subject product, information relating to comparison results (matches/mismatches) between the characteristics given to the subject individual and the characteristics given to the purchased individual
When the customer has not previously purchased one of the individuals of the subject product, information indicating that the product is being purchased for the first time

After step S105a, the user terminal 10 executes presentation of the information (S106).

More specifically, the processor 12 presents the information determined in step S105a to the customer by outputting the information to the output device 16.

As described above, the user terminal of modification example 2 applies individual differences to the subject product at the point of sale. According to the user terminal of modification example 2, therefore, mismatches between supply and demand, such as when the inventory of individuals of the subject product having/not having specific individual properties becomes extremely low at the store or, conversely, a large number of individuals having/not having specific individual properties are left unsold, can be prevented. For example, the store can sell a subject product having many individual differences without excessively increasing the inventory.

### (5-3) Modification Example 3

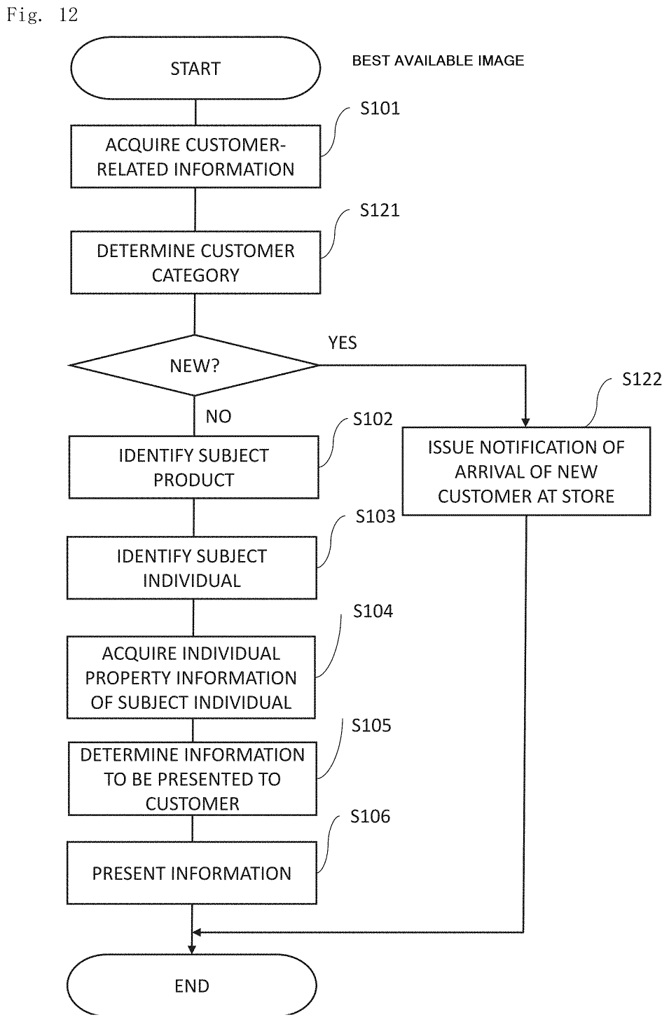

Modification example 3 will now be described. Modification example 3 is an example in which purchase support for new customers is given when the customer is a new customer. A new customer is a customer who is not a member of the store or the store group, for example. FIG. 12 is a view showing a flow of information provision processing according to modification example 3.

As shown in FIG. 12, the user terminal 10 executes acquisition of the customer-related information (S101) in a similar manner to FIG. 8.

After step S101, the user terminal 10 executes customer category determination (S121).

More specifically, the processor 12 determines the category of the customer by referring to the customer-related information acquired in step S101. For example, the processor 12 determines that the customer is a new customer when purchase history information for the customer is not registered in the purchase history database.

When it is determined in step S121 that the customer is not a new customer, the user terminal 10 executes identification of the subject product (S102), identification of the subject individual (S103), acquisition of the individual property information of the subject individual (S104), determination of the information to be presented to the customer (S105), and presentation of the information (S106) in a similar manner to FIG. 8. Alternatively, the user terminal 10 executes identification of the subject product (S102), identification of the subject individual (S103), determination of the individual properties of the subject individual (S111), application of the individual properties (S112), determination of the information to be presented to the customer (S105a), and presentation of the information (S106) in a similar manner to FIG. 11.

When it is determined in step S121 that the customer is a new customer, the user terminal 10 issues a notification of the arrival of a new customer at the store (S122). For example, the user terminal 10 transmits a notification to the store terminal 20 (for example, a customer service robot or a terminal in the possession of a salesperson). Following the notification, at least one of the following types of purchase support, for example, is given to the customer.

Presentation of a store guide
Presentation of a product guide
Presentation of a guide to a method for checking the individual properties of the subject individual
Presentation of a guide to member registration
Customer service by a customer service robot or a salesperson
Implementation of a preference questionnaire or a personality test

As described above, the user terminal of modification example 3 provides the customer with purchase support for new customers by determining the category of the customer and issuing a notification of the arrival of a new customer at the store. According to the user terminal of modification example 3, therefore, the customer can be helped to understand the concepts of the store, the product, and the purchasing system in advance.

### (5-4) Modification Example 4

Modification example 4 will now be described. Modification example 4 is an example in which the information relating to the characteristics given to the subject individual is presented during or after purchase of the subject individual rather than before purchase of the subject individual.

In modification example 4, the “New” mark MK11 of FIG. 4 means that none of the individuals of the subject product purchased by the customer prior to the subject individual have the characteristic “personality: gentle”. Similarly, according to modification example 4, the “New” mark MK12 of FIG. 5 means that none of the individuals of the subject product purchased by the customer prior to the subject individual have the characteristic “personality: mischievous”.

As described above, the user terminal of modification example 4 presents the information relating to the characteristics given to the subject individual during or after purchase of the subject individual rather than before purchase of the subject individual. According to the user terminal of modification example 4, therefore, the user can decide to purchase the subject individual while looking forward to finding out the characteristics given to the subject individual, and can enjoy checking the actual characteristics during or after purchase.

Note that in modification example 4, the timing at which the characteristics are given to the subject individual may be set as desired. More specifically, the characteristics may be given during manufacture or given at the point of sale, as in modification example 2.

### (6) Other Modification Examples

The storage device 11 may be connected to the user terminal 10 by the network NW.

In the example described in this embodiment, the “New” mark is added and displayed in relation to a characteristic, among the characteristics of the subject individual, that none of the individuals of the subject product previously purchased by the customer have. The present disclosure is not limited to the “New” mark, however, and the “New” mark may be replaced by any other form of display with which it is possible to distinguish between a characteristic, among the characteristics of the subject individual, that none of the individuals of the subject product previously purchased by the customer have and other characteristics. For example, a characteristic, among the characteristics of the subject individual, that none of the previously purchased individuals of the subject product have may be displayed in bold.

The user terminal 10 may present the customer with the individual property information of previously purchased individuals in addition to the individual property information of the subject individual. Thus, the customer can make a purchasing decision by comparing the individual property information of the subject individual with the individual property information of previously purchased individuals.

In the examples of the embodiment and the modification examples, the user terminal 10 directly accesses the customer information management device 30 and the product information management device 40. However, the store terminal 20 or an intermediary device (for example, a web server) in the drawings may exist between the user terminal 10 and the customer information management device 30 and product information management device 40.

In the examples of the embodiment and the modification examples, the customer visits an actual store, but the store may be provided in a virtual space. When the store is provided in a virtual space, the objects in the store (for example, the store terminal 20, the individuals of the product, and structures constituting the store) may be replaced by virtual objects, and the salespeople may be replaced by avatars.

In the examples of the embodiment and the modification examples, the user terminal 10 functions as an information provision device. However, the store terminal 20 may also function as an information provision device, and the user terminal 10 and store terminal 20 may function cooperatively as an information provision device. In other words, the respective steps of the information provision processing described above can be executed by either the user terminal 10 or the store terminal 20.

In the example of modification example 1, the subject product and the subject individual are identified by referring to the inventory information and the customer-related information. However, the subject product may be identified by customer specification, and the subject individual may be identified by referring to the inventory information and the customer-related information.

In the example of modification example 2, the individual properties of the subject individual are determined and applied when the information relating to the subject individual is presented. However, the timing at which the individual properties are essentially applied to the subject individual (in other words, the timing at which the information stored in the database or on the information carrier attached to the subject individual is rewritten) is not limited to the example of FIG. 11. For example, the store terminal 20 (a payment terminal) may apply the individual properties to the subject individual when the customer purchases the subject individual.

In the example of modification example 3, the purchase support for new customers is given when the customer is a new customer. Instead, however, purchase support for customers in another specific category may be given when the customer corresponds to that specific category. For example, by referring to the purchase history information of the customer, customers for whom a long time has passed since their previous purchase, customers who have made large purchases, customers who make frequent purchases, and so on can be differentiated.

In the example of modification example 4, some of the information relating to the characteristics given to the subject individual may be displayed before the subject individual is purchased. Thus, the customer can decide to purchase the subject individual while partially knowing the characteristics given to the subject individual and looking forward to finding out the hidden characteristics, and can enjoy checking what the hidden characteristics actually are either during or after purchase. For example, at least one of the following types of information may be displayed before the subject individual is purchased.

Information relating to some predetermined items of the individual property information
Information relating to some items determined at random from the individual property information
Information relating to the same characteristics as those of previously purchased individuals, from the individual property information
Information (for example, the “New” mark) indicating at least one of match or mismatch between the characteristics given to previously purchased individuals and the characteristics given to the subject individual

The information presented to the customer in relation to at least one of the subject product and the subject individual and information indicating which product and which individual thereof the customer subsequently purchased or did not purchase may be collected in order to analyze the products or individual properties favored/not favored by the customer. The analysis result can be used as material for product development.

Customer data relating to the game, application, service, or platform related to the subject product may be updated in accordance with the individual properties given to the subject individual. For example, data relating to characters having the same individual properties as the subject individual purchased by the customer may be added to the game data of the customer.

An embodiment of the present dislcosure was described in detail above, but the scope of the present disclosure is not limited to the above embodiment. Moreover, various amendments and modifications may be applied to the above embodiment within a scope that does not depart from the spirit of the present disclosure. Furthermore, the embodiment and the modification examples described above may be combined.

### (7) Supplements

The matters described in the embodiment and modification examples are supplemented as follows.

### (Supplement 1)

An information provision device including:

means for acquiring information relating to a customer (S101); and

means for referring to at least the information relating to the customer in order to present the customer with information relating to characteristics given to a subject individual, which is one individual of a subject product to which characteristics are individually given so that individual differences exist between individuals of the same item (S105).

### (Supplement 2)

The information provision device described in supplement 1,

wherein the information relating to the customer includes information relating to a purchase history of the customer.

### (Supplement 3)

The information provision device described in supplement 2,

wherein, when the customer has previously purchased one of the individuals of the subject product, the presenting means presents information relating to the characteristics given to the purchased individual.

### (Supplement 4)

The information provision device described in supplement 2,

wherein the presenting means presents information indicating whether or not one of the individuals of the subject product has previously been purchased by the customer, and when one of the individuals of the subject product has previously been purchased by the customer, the presenting means further presents information (MK11, MK12) indicating at least one match or mismatch between the characteristics applied to the purchased individual and the characteristics applied to the subject individual.

### (Supplement 5)

The information provision device described in supplement 2,

wherein the presenting means presents information indicating whether or not one of the individuals of the subject product has previously been purchased by the customer, and when one of the individuals of the subject product has previously been purchased by the customer, the presenting means further presents information indicating the characteristics applied to the purchased individual and information indicating the characteristics applied to the subject individual.

### (Supplement 6)

The information provision device described in any of supplements 2 to 5, further including means for identifying the subject individual in response to specification thereof by the customer (S103).

### (Supplement 7)

The information provision device described in any of supplements 1 to 6,

wherein the information relating to the customer includes at least one of a use history of the customer in relation to at least one of a game, an application, a service, and a platform related to the product, and information relating to at least one of the preferences and the personality of the customer.

### (Supplement 8)

The information provision device described in any of supplements 1 to 7,

wherein the presenting means presents the customer with information relating to the characteristics given to the subject individual after additionally referring to information relating to an inventory of the product.

### (Supplement 9)

The information provision device described in supplement 8, further including:

means for identifying a product for which there is inventory as the subject product (S102); and

means for identifying an individual of the identified subject product as the subject individual (S103).

s(Supplement 10)

The information provision device described in any of supplements 1 to 9, further including means for determining the characteristics to be given to the subject individual (S111).

### (Supplement 11)

The information provision device described in supplement 10, further including means for giving the characteristics determined by the means for determining to the subject individual (S112).

### (Supplement 12)

The information provision device described in any of supplements 1 to 11, further including:

means for determining whether or not the customer is a new customer (S121); and

means for issuing a notification of the arrival of a new customer at a store when the customer is determined to be a new customer (S122).

1. An information provision device, comprising:
processing circuitry configured to
acquire information relating to a customer, and
refer to at least the information relating to the customer in order to present the customer with information relating to characteristics given to a subject individual, which is one individual of a subject product to which characteristics are individually given so that individual differences exist between individuals of a same item.

2. The information provision device according to claim 1,
wherein the information relating to the customer includes information relating to a purchase history of the customer.

3. The information provision device according to claim 2,
wherein, when the customer has previously purchased one of the individuals of the subject product, the processing circuitry is configured to present information relating to the characteristics given to the purchased individual.

4. The information provision device according to claim 2,
wherein the processing circuitry is further configured to
present information indicating whether or not one of the individuals of the subject product has previously been purchased by the customer, and
when one of the individuals of the subject product has previously been purchased by the customer, present information indicating at least one of match or mismatch between the characteristics applied to the purchased individual and the characteristics applied to the subject individual.

5. The information provision device according to claim 2,
wherein the processing circuitry is further configured to
present information indicating whether or not one of the individuals of the subject product has previously been purchased by the customer, and
when one of the individuals of the subject product has previously been purchased by the customer, present information indicating the characteristics applied to the purchased individual and information indicating the characteristics applied to the subject individual.

6. The information provision device according to claim 5, wherein the processing circuitry is further configured to
identify the subject individual in response to specification thereof by the customer.

7. The information provision device according to claim 6,
wherein the information relating to the customer includes at least one of a use history of the customer in relation to at least one of a game, an application, a service, and a platform related to the product, and information relating to at least one of preferences and a personality of the customer.

8. The information provision device according to claim 7,
wherein the processing circuitry is further configured to present the customer with information relating to the characteristics given to the subject individual after additionally referring to information relating to an inventory of the product.

9. The information provision device according to claim 8, wherein the processing circuitry is further configured to
identify a product for which there is inventory as the subject product, and
identify an individual of the identified subject product as the subject individual.

10. The information provision device according to claim 9, wherein the processing circuitry is further configured to
determine the characteristics to be given to the subject individual.

11. The information provision device according to claim 10, wherein the processing circuitry is further configured to
give the determined characteristics to the subject individual.

12. The information provision device according to claim 11, wherein the processing circuitry is further configured to
determine whether or not the customer is a new customer, and
issue a notification of the arrival of a new customer at a store when the customer is determined to be a new customer.

13. An information provision method, comprising:
acquiring information relating to a customer; and
referring to at least the information relating to the customer in order to present the customer with information relating to characteristics given to a subject individual, which is one individual of a subject product to which characteristics are individually given so that individual differences exist between individuals of a same item.

14. A non-transitory computer-readable program storing computer-readable instructions thereon which, when executed by a computer, cause the computer to perform a method, the method comprising:
acquiring information relating to a customer; and
referring to at least the information relating to the customer in order to present the customer with information relating to characteristics given to a subject individual, which is one individual of a subject product to which characteristics are individually given so that individual differences exist between individuals of a same item.

15. An information provision system, comprising:
means for acquiring information relating to a customer; and
means for referring to at least the information relating to the customer in order to present the customer with information relating to characteristics given to a subject individual, which is one individual of a subject product to which characteristics are individually given so that individual differences exist between individuals of a same item.
